(19) United States
(12) Patent Application Publication
(10) Pub. No.: US 2015/0282498 A1
(43) Pub. Date: Oct. 8, 2015

(54) Powder Containing Polyunsaturated Fatty Acids and Process for Making Same

(71) Applicant: Cognis IP Management GmbH, Dusseldorf (DE)

(72) Inventors: Peter Horlacher, Bellenberg (DE); Robert Salacz, Blaustein (DE); Alois Hofmann, Illertsen (DE); Jürgen Gierke, lllertissen/Betlinshausen (DE)

(21) Appl. No.: 14/688,265

(22) Filed: Apr. 16, 2015

Related U.S. Application Data
(63) Continuation of application No. 11/857,496, filed on Sep. 19, 2007, now abandoned.

(30) Foreign Application Priority Data
Sep. 22, 2006 (EP) 06019849.6

(51) Int. Cl. A23D 9/00; A23L 2/52; A23D 9/05; A23D 9/007; A23L 1/30

(52) U.S. Cl. CPC A23D 9/00; A23D 9/007; A23L 1/3008; A23D 9/05; A23L 2/52; A23V 2002/00

(57) ABSTRACT

A powder containing particles, which particles include gum arabic and at least one polyunsaturated fatty acid (PUFA) ester, where the ratio by weight of the quantity of gum arabic present in the particles to the quantity of the polyunsaturated fatty acid ester present in the particles is from about 1:1.4 to about 1:0.25, is provided. A process for the production of the particles is also provided.

### CROSS-REFERENCE TO RELATED APPLICATIONS

This application is a continuation of U.S. application Ser. No. 11/857,496, filed on Sep. 19, 2007, which claims priority under 35 U.S.C. §119 to European Patent Application No. 06019849.6, filed Sep. 22, 2006, the contents of which are herein incorporated by reference in their entireties.

### BACKGROUND OF THE INVENTION

1. Field of the Invention

This invention relates generally to a powder containing particles which contain gum arabic, and at least one polyunsaturated fatty acid ester, and more particularly, to a powder containing particles which contain gum arabic, and at least one polyunsaturated fatty acid ester, where the ratio by weight of the quantity of gum arabic present in the particles to the quantity of all polyunsaturated fatty acid esters present in the particles is from about 1:1.4 to about 1:0.25. The invention also relates to a process for the production of the powder and to foods containing the powder.

2. Background Information

Polyunsaturated fatty acids (PUFAs) are added to foods for various reasons because they have many health benefits. PUFAs are often used in the form of their esters with glycerol, i.e., triglycerides are used, at least one of the acyl groups being a PUFA acyl group and—for the rest—acyl groups of other fatty acids being present. However, other esters of PUFAs, for example, esters with fatty alcohols, may also be used.

The foods which may include PUFAs include milk, milk beverages, whey beverages, yogurt beverages, juices, margarines and other foods. The PUFA esters or the conjugated linoleic acid (CLA) esters should therefore be guaranteed protection against oxidative damage. In addition, it is desirable to be able to add the PUFA esters, more particularly the CLA esters, to the foods in a sufficient quantity to achieve the desired health benefits.

With water-based foods, such as juices for example, it is a problem that PUFA esters, more especially CLA esters, are lipophilic substances. Lipophilic substances can be introduced into water-containing systems as emulsified droplets.

Emulsions are often used in this regard. Although they can readily be incorporated in beverages, emulsions do contain emulsifiers such as, for example, lecithin, polysorbate, sugar esters, citrems, etc. Such emulsions very often contain large quantities of water and, accordingly, have only a limited shelf life. Because the risk of microbiological contamination exists, the products have to be packed under sterile conditions and kept cool in storage. The active substance contents (for example CLA esters) are frequently limited and, often, are at most in the range from 20 to 30% by weight.

In addition, the use of the above-mentioned emulsifiers has a negative effect on the sensory properties of the end products (for example foods). Accordingly, it would be desirable to have products available which would not require any of the above-mentioned lipophilic emulsifiers.

JP-A 2000-050841 discloses a composition containing (a) 60 to 85 parts by weight of an oily liquid which contains 65% by weight conjugated linoleic acid (CLA) and (b) 15 to 40 parts by weight gum arabic. This mixture may also contain vitamin E. Accordingly, this means that the ratio of gum arabic to oily liquid is 1:1.5 to 1:5.67. Unfortunately, these powders are difficult to stabilize against oxidative damage. In addition, emulsifiers have to be added to these compositions to achieve effective encapsulation of the CLA-containing oil. This gives rise to the disadvantages described above, for example sensory disadvantages.

EP-A 1 634 502 discloses an emulsion containing 0.1 to 50% by weight conjugated linoleic acid (CLA) or derivatives of conjugated linoleic acid and 0.1 to 30% by weight vegetable lecithin mixtures and 20 to 99% by weight water.

WO 01/78531 and the US equivalent U.S. Pat. No. 6,756,405 disclose a powder containing a CLA-containing oil and a carrier which may be, for example, starch, sucrose or lactose. The powder may be produced by spray drying.

EP 1 598 413 A1 discloses a powder containing polyunsaturated fatty acid esters (PUFA esters) of ascorbic acid and gum arabic. The powder is produced by spray drying of an emulsion produced with the PUFA ester and excipients. It is mentioned that the PUFA esters and their powders have improved stability against oxidation. The powder composition is also used in foods.

WO 2004/009071 (for example claims 1 to 34 and Examples 15 to 19) describes powders containing CLA esters. There is no mention of gum arabic. Reference is made in particular to the high content of CLA ester in these powders which are used, inter alia, in foods.

US 2006/088574 describes polyunsaturated fatty acids (DHA) which may preferably be present in the form of ethyl esters or triglycerides. A DHA food supplement in powder form which also contains gum arabic is also disclosed.

JP 2000-050841 discloses a CLA powder.

There remains a need for a component containing PUFA esters and method for making the component system, by which PUFA esters can be added to foods.

### SUMMARY OF THE INVENTION

Briefly described, according to an aspect of the invention, a powder including particles is provided, which particles include: gum arabic; and at least one polyunsaturated fatty acid ester, where the ratio by weight of the quantity of gum arabic present in the particles to the quantity of the polyunsaturated fatty acid ester present in the particles is from about 1:1.4 to about 1:0.25.

According to another aspect of the invention, a process for the production of a particle includes the steps of: providing a mixture comprising water, gum arabic, and at least one polyunsaturated fatty acid ester, where the ratio by weight of the quantity of gum arabic present in the particles to the quantity of the polyunsaturated fatty acid ester present in the particles is from about 1:1.4 to about 1:0.25; and spray drying the mixture to form particles.

### DETAILED DESCRIPTION OF THE INVENTION

The stated problem is solved by a powder containing particles which contain gum arabic, at least one polyunsaturated fatty acid (PUFA) ester and, optionally, at least one antioxidant, the ratio by weight of the quantity of gum arabic present in the particles to the quantity of all PUFA esters present in the particles being from 1:1.4 to 1:0.25, according to an aspect of the present invention.

The quantity ratio of 1:1.4 to 1:0.25 is a key feature of the present invention. Adherence to this quantity ratio is necessary in order to guarantee the advantageous properties of the powder according to the invention. This is illustrated by the Examples of the present specification. As these Examples show, adherence to the quantity ratio mentioned guarantees high oxidation stability of the powder according to the invention. In addition, adherence to that quantity ratio guarantees favorable dispersion behavior of the powder according to the invention in water. Adherence to the quantity ratio mentioned also guarantees favorable tabletting behavior of the powder according to the invention.

In one particular embodiment of the present invention, the ratio by weight of the quantity of gum arabic to the quantity of all PUFA esters present is from 1:1.25 to 1:0.66.

In another particular embodiment of the present invention, the particles have a mean size of 100 nm to 1 mm.

In another particular embodiment of the present invention, the content of acyl groups containing at least two C-C double bonds, based on the quantity of all PUFA esters present, is at least 72% by weight.

In another particular embodiment of the present invention, the PUFA esters are CLA esters (more especially CLA esters of glycerol which contain at least one acyl group derived from CLA).

In another particular embodiment of the present invention, the antioxidant is selected from the group consisting of a tocopherol, ascorbyl palmitate, sodium ascorbate, ascorbic acid, citric acid and a salt of these substances.

The present invention also relates to a process for the production of the powder according to the invention which comprises the steps of preparing a mixture containing water, gum arabic, at least one PUFA ester and, optionally, at least one antioxidant and spray drying this mixture.

The present invention also relates to the use of the powder according to the invention for the production of a food (more especially a food selected from the group consisting of milk, milk beverages, whey beverages, yogurt beverages, juices and margarine).

The present invention also relates to a food containing the powder according to the invention. In one particular embodiment of the present invention, the food is selected from the group consisting of milk, a milk beverage, a whey beverage, a yogurt beverage, a juice and margarine.

A PUFA ester in the context of the present invention is any ester of a fatty acid containing at least two C—C double bonds with an alcohol, more especially an ester of a fatty acid containing at least two C—C double bonds with glycerol, at least one OH group of the glycerol being esterified and this ester with glycerol containing at least one acyl group which in turn contains at least two C—C double bonds. PUFA esters, more especially those with glycerol, which contain at least one acyl group derived from CLA (such PUFA esters are called CLA esters) are preferred. In a CLA, the two double bonds are located at carbon atoms n and n+2 (n is a natural number of 2 to 15). In octadecadienoic acid, for example, the double bonds are preferably either at positions 9 and 11 (9,11-octadecadienoic acid) or at positions 10 and 12 (10,12-octadecadienoic acid). Cis-trans isomerism (E-Z isomerism) is possible at each double bond. The possible isomers for CLA are denoted by the letters c for cis and t for trans and by numbers for the position of the double bonds, i.e., for example c9,t11-CLA.

Preferred PUFA esters are triacyl glycerides which contain at least one CLA acyl group and, for the rest, contain acyl groups of other fatty acids and in which the CLA acyl group is derived from c9,t11-octadecadienoic acid or from t10,c12-octadecadienoic acid.

The powders according to the invention avoids the disadvantages of the known products.

The powders according to the present invention have many advantages over the powders according to JP-A 2000-050841. In particular, a content of CLA in the powder comparable with that described in JP-A 2000-050841 can be achieved and oxidation stability can be improved. No emulsifiers are needed to produce the powders according to the present invention. For comparison, Example 3 of JP-A 2000-050841 shows that corresponding products with no emulsifier according to the teaching of JP-A 2000-050841 are not stable to oxidation. This is reflected in the formation of peroxide at 40° C. in Example 3 of JP-A 2000-050841, Tables 1 and 2. This Example of JP-A 2000-050841 shows that effective encapsulation in this case can only be achieved with emulsifiers.

In addition, the powders according to the invention show advantageous sedimentation properties by comparison with the products of JP-A 2000-050841 when added to beverages. The powders according to the invention settle very slowly, if at all. By comparison, the products according to JP-A 2000-050841 show unfavorable sedimentation behavior.

One advantage of the powders according to the invention is that they can be produced, for example, by spray drying without any need to use an emulsifier.

In addition, the powders according to the invention have advantageous sensory properties. The powders are satisfactory both in regard to odor and in regard to taste.

The powders according to the invention also show advantageous dispersion behavior. The powders can readily be stirred into water-based preparations such as, for example, fruit juices, sports beverages, milk, etc., and then further processed.

Another advantage of the powders according to the invention is that they have very good flow properties with little tendency to form lumps.

The powders according to the invention can be produced. in particular, by spray drying. They can also be produced by other methods. For example, the powders according to the invention can be produced by fluidized bed granulation, spray granulation, contact drying, or spray cooling. The powders according to the invention can also be produced by coating or extrusion processes. Production using so-called jet dispersers is possible.

Antioxidants which may be used in the powders according to the invention are any known antioxidants. In particular, tocopherols or mixtures of tocopherols, ascorbyl palmitate, sodium ascorbate, ascorbic acid, citric acid or salts of the substances mentioned may be used.

The invention is described herein with reference to specific embodiments. One of ordinary skill in the art, however, appreciates that various modifications and changes can be made without departing from the scope of the invention as set forth in the claims. Accordingly, the specification is to be regarded in an illustrative manner, rather than a restrictive view and all such modifications are intended to be included within the scope of the invention.

### EXAMPLES

1400 g water were heated to ca. 70° C. 319 g gum arabic (DM 94%) were added with stirring (“DM 94%” means a dry matter content of 94% by weight; like other carbohydrates, gum arabic also has a certain residual moisture content). 300 g Tonalin® TG 80 (CLA triglyceride from Cognis Deutschland GmbH & Co. KG, Monheim, Germany) were then added. The mixture was then homogenized (220/30 bar) and spray dried (using an APV Anhydro type 3S spray dryer) in two stages.

Spray drying conditions:
Entry temperature: 185° C.
Exit temperature: 90° C.

### Atomizer: 24,000 r.p.m.

Particle size: d90<2.5 μm

By comparison with an emulsion, a powder produced in this way had sensory advantages in the respect that up to 3 times the quantity of CLA could be incorporated in a beverage without sensory impairment. When flavors were additionally used, even larger quantities of CLA could be incorporated. By contrast, known emulsions have to be flavored because, otherwise, they can only be used in very small quantities for sensory reasons.

TABLE
Content of CLA triglyceride in various beverages using either an
emulsion or a powder (without sensory impairment; % = % by weight)

| | CLA Emulsion | CLA Powder |
|---|---|---|
| Multivitamin juice | 0.2% | 0.5% |
| Banana nectar | 0.3% | 1.0% |
| Peach nectar | 0.1% | 0.75% |
| Vegetable juice | 0.2% | 1.0% |

Emulsions are also capable of lightening the color of beverages, which is undesirable. This property is barely noticeable with a powder according to the invention.

### Other Examples

The following four powders (AH 65 to AH 68) were produced by spray drying and tested.

| | AH 65 | AH 66 | AH 67 | AH 68 |
|---|---|---|---|---|
| Tonalin ® TG 80 | 20% | 58% | 70% | 80% |
| Gum arabic 94% DM | 80% | 42% | 30% | 20% |
| Ascorbyl palmitate | 500 ppm | 500 ppm | 500 ppm | 500 ppm |

Tonalin® TG 80 is a CLA triglyceride (80% by weight CLA, based on all fatty acid esters). The content of free, i.e., non-matrix-encapsulated, surface oil was determined. The following results were obtained:

### AH 65: 0.37%

### AH 66: 18.3%

### AH 67: 29.5%

### AH 68: 46.3%

As the content of free surface oil increases, the stability of the product to oxidation is lost. It can be seen that even AH 66 is at the limit.

Stirring behavior in water was tested. To this end, the powder (quantity calculated for 2 g Tonalin® TG 80 to 1 liter water) was stirred in at room temperature using a magnetic stirrer. The dispersion was then left unstirred for 1 hour and evaluated.

### Result:

AH 65: stirrable, stable, no creaming
AH 66: stirring, stable, minimal creaming
AH 67: stirrable, unstable, creaming, ring formation
AH 68: stirrable, unstable, serious creaming and ring formation

Tabletting behavior was tested. Tablets were produced from the powders with two different pressures (p1=1 t/cm² and p2=2t/cm²) and then evaluated.

### Result:

AH 65: p1 OK, no visible oiling out, p2 OK, no visible oiling out
AH 66: p1 OK, no visible oiling out, p2 still OK, minimal oiling out
AH 67: p1 still OK, minimal oiling out, p2 production impossible, product oils out immediately
AH 68: p1 production impossible, product oils out immediately, p2 production impossible, product oils out immediately.

1. A powder comprising particles, the particles comprising:
(a) gum arabic; and
(b) one or more polyunsaturated fatty acid esters of glycerol, wherein the ratio by weight of the quantity of gum arabic present in the particles to the quantity of the polyunsaturated fatty acid ester present in the particles is about 1:1.4 to about 1:0.25, and wherein said powder is stable against oxidation, disperses in water, and can be formed into tablets.

2. The powder according to claim 1, wherein the particles further comprise at least one antioxidant.

3. The powder according to claim 1, wherein the ratio by weight of the quantity of gum arabic present in the particles to the quantity of the polyunsaturated fatty acid ester present in the particles is about 1:1.25 to about 1:0.66.

4. The powder according to claim 1, wherein the particles have a mean size of about 100 nm to about 1 mm.

5. The powder according to claim 1, wherein the content of acyl groups containing at least two C—C double bonds in the polyunsaturated fatty acid ester, based on the quantity of the polyunsaturated fatty acid ester present, is at least 72% by weight.

6. The powder according to claim 1, wherein the polyunsaturated fatty acid esters of glycerol comprises a conjugated linoleic acid ester.

7. The powder according to claim 2, wherein said at least one antioxidant is selected from the group consisting of: a tocopherols, ascorbyl palmitate, sodium ascorbate, ascorbic acid, citric acid, citric acid salts and combinations thereof.

8. A process for the production of particles, comprising the steps of:
(a) providing a mixture comprising water, gum arabic, and one or more polyunsaturated fatty acid esters of glycerol, wherein the ratio by weight of the quantity of gum arabic present in the particles to the quantity of the polyunsaturated fatty acid ester present in the particles is about 1:1.4 to about 1:0.25; and
(b) spray drying said mixture to form particles, wherein the particles are stable against oxidation, disperse in water, and can be formed into tablets.

9. The process according to claim 8, wherein the mixture further comprises at least one antioxidant.

10. The process according to claim 8, wherein the ratio by weight of the quantity of gum arabic present in the particles to the quantity of the polyunsaturated fatty acid ester present in the particles is about 1:1.25 to about 1:0.66.

11. The process according to claim 8, wherein the particles have a mean size of about 100 nm to about 1 mm.

12. The process according to claim 8, wherein the content of acyl groups containing at least two C—C double bonds in the polyunsaturated fatty acid ester, based on the quantity of the polyunsaturated fatty acid ester present, is at least 72% by weight.

13. The process according to claim 8, wherein said polyunsaturated fatty acid ester comprises a conjugated linoleic acid ester.

14. The process according to claim 9, wherein said at least one antioxidant is selected from the group consisting of tocopherols, ascorbyl palmitate, sodium ascorbate, ascorbic acid, citric acid, citric acid salts and combinations thereof.

15. The powder according to claim 1, incorporated into a food product.

16. The powder according to claim 15, wherein said food product is selected from the group consisting of milk, milk beverages, whey beverages, yogurt beverages, juices, and margarines.

17. The powder according to claim 1, in the form of a tablet.

18. The powder of claim 1, wherein said one or more polyunsaturated fatty acid esters comprise polyunsaturated fatty acid esters of glycerol.

19. The process of claim 8, wherein said one or more polyunsaturated fatty acid esters comprise polyunsaturated fatty acid esters of glycerol.

20. A powder comprising particles, the particles consisting of:
(a) gum arabic; and
(b) one or more polyunsaturated fatty acid esters of glycerol,
wherein the ratio by weight of the quantity of gum arabic to the quantity of the polyunsaturated fatty acid ester present in said particles is about 1:1.4 to about 1:0.25, and wherein said powder is stable against oxidation, disperses in water, and can be formed into tablets.

21. The powder according to claim 1 that is free of any emulsifiers.

22. The process according to claim 8, wherein no emulsifiers are present in the mixture.
